(19) United States
(12) Patent Application Publication
(10) Pub. No.: US 2016/0299770 A1
(43) Pub. Date: Oct. 13, 2016

(54) OPEN COLLECTOR OUTPUT ON A GENERAL PURPOSE INPUT/OUTPUT PIN

(71) Applicant: General Electric Company, Schenectady, NY (US)

(72) Inventors: Tyler James Doering, Louisville, KY (US); Jose Rafael Padron, Louisville, KY (US)

(21) Appl. No.: 14/681,411

(22) Filed: Apr. 8, 2015

(51) Int. Cl. G06F 9/445; G06F 1/26; G06F 13/10

(52) U.S. Cl. CPC G06F 9/44505; G06F 13/102; G06F 1/26

(57) ABSTRACT

Systems and methods for providing an open collector output at a general purpose input/output (GPIO) pin of a microcontroller are provided. A pull-up resistor can be coupled between an external supply voltage and an output node associated with the GPIO pin. The microcontroller can be configured to provide an open collector high logic level at the output node by setting the GPIO pin as an input pin. In such configuration, the output at the output node can be determined based at least in part on the supply voltage. The microcontroller can be further configured to provide an open collector low logic level at the output node by setting the GPIO pin as an output pin and further configuring the GPIO pin to have a low logic output level.

### FIELD OF THE INVENTION

The present disclosure relates generally to microcontrollers, and more particularly to providing an open collector output on a general purpose input/output pin associated with a microcontroller.

### BACKGROUND OF THE INVENTION

Controllers, such as microcontrollers, can be used in computing systems to control or regulate various components and/or peripheral devices associated with the computing systems. For instance, controllers can be used in automobile engine control systems, implantable medical devices, remote controls, appliances and the like. A controller can have one or more input and/or output pins that can be used to implement one or more functions. For instance, a pin associated with a controller can be configured as a general purpose input/output (GPIO) pin. A GPIO pin is a pin that can be configured as an input pin or an output pin. A GPIO pin can be used, for instance, to interface the controller to other devices.

A pin associated with a controller can be configured to provide an open collector output. In an open collector output, an output signal is applied to the base of an internal NPN transistor (e.g. a bipolar junction transistor (BJT)) associated with the controller, and the collector of the transistor is externalized on the pin of the controller.

For instance, FIG. 1 depicts an example open collector implementation 100 that can be used in a variety of applications. Open collector implementation 100 includes a microcontroller 102. Microcontroller 102 includes a BJT 104 having a base, a collector, and an emitter. A voltage can be applied to the base of BJT 104, for instance, by writing to the control register associated with BJT 104. When this voltage is sufficient to forward bias the base-emitter junction of BJT 104, BJT 104 can be turned on such that a current can flow through the collector and emitter of BJT 104. Accordingly, when the emitter of BJT 104 is coupled to ground, the open collector output can be pulled towards the ground value. If the voltage applied to the base of BJT 104 is not sufficient to forward bias the base-emitter junction, the transistor can be turned off such that current flow through the collector and emitter is limited, and the open collector output can be a floating output.

A floating output can be an output having an undefined value that varies between a high logic level and a low logic level. To compensate for floating outputs, a current limiting device can be coupled between a supply voltage and the open collector output. A current liming device can include one or more circuit elements that imposes an upper limit on the amount of current that can be delivered to a load. For instance, FIG. 1 depicts a pull-up resistor (e.g. current limiting device) 106 coupled between a supply voltage 108 and the open collector output. When current flow through the collector and emitter of BJT 104 is limited, the pull-up resistor can pull the open collector output towards the supply voltage 108 (e.g., to a high logic level). It will be appreciated by those skilled in the art that other suitable transistor implementations may be used without deviating from the scope of the present disclosure. For instance, a field-effect transistor (e.g. MOSFET) can be used to provide an open drain output having the same or substantially the same functionality.

Open collector outputs can be useful, for instance, in level shifting between logic levels. A level shifter can facilitate communication between computing devices that have different associated operating voltages. For instance, an open collector output can be used to interface a device having a 3.3V operating voltage and a device having a 5V operating voltage.

### BRIEF DESCRIPTION OF THE INVENTION

Aspects and advantages of the invention will be set forth in part in the following description, or may be obvious from the description, or may be learned through practice of the invention.

One example embodiment of the present disclosure is directed to a system for providing an open collector output. The system includes a general purpose input/output (GPIO) pin associated with one or more processing devices. The system further includes a current limiting device coupled between a supply voltage and an output node associated with the GPIO pin. The supply voltage is external to the one or more processing devices. The one or more processing devices are configured to provide a first logic level at the output node by setting the GPIO pin as an input pin. The first logic level corresponds to a high logic level. The first logic level is determined based at least in part on the supply voltage.

Another example embodiment of the present disclosure is directed to a method of providing an open collector output at a GPIO pin associated with one or more processing devices. The method includes configuring the GPIO pin as an input pin. The method further includes, responsive to configuring the GPIO pin as an input pin, providing an open collector high output state at an output node associated with the GPIO pin. The open collector high output state is determined based at least in part on a supply voltage coupled to the output node. The supply voltage is external to the one or more processing devices.

Another example embodiment of the present disclosure is directed to an appliance. The appliance includes one or more processing devices having an associated general purpose input/output (GPIO) pin. The appliance further comprises a current limiting device coupled between a supply voltage and an output node associated with the GPIO pin. The supply voltage is external to the one or more processing devices. The one or more processing devices are configured to provide a first logic level at the output node by setting the GPIO pin as an input pin. The first logic level corresponds to a high logic level. The first logic level is determined based at least in part on the supply voltage.

Variations and modifications can be made to these example embodiments of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an example open collector output implementation according to example embodiments of the present disclosure;

FIG. 2 depicts an example appliance according to example embodiments of the present disclosure;

FIG. 3 depicts an example open collector output at a GPIO pin according to example embodiments of the present disclosure; and

FIG. 4 depicts an example open collector output at a GPIO pin according to example embodiments of the present disclosure.

FIG. 5 depicts a flow diagram of an example method of providing an open collector high logic output at a GPIO pin according to example embodiments of the present disclosure.

FIG. 6 depicts a flow diagram of an example method of providing an open collector low logic output at a GPIO pin according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to providing an open collector output at a general purpose input/output (GPIO) pin of a controller. Configuring a GPIO pin as an open collector output according to example aspects of the present disclosure can provide added functionality to a controller by allowing any GPIO pin on the controller to provide an open collector output. As described above, a GPIO pin can be set as an input pin or an output pin. In particular, a control register associated with the GPIO pin can determine whether the pin is configured as an input pin or an output pin. When configured as an output pin, a data register associated with the GPIO pin can determine whether the pin outputs at a high logic level or a low logic level (e.g., a one or a zero). When configured as an input pin, the data register can read the logic level at the input pin.

According to example embodiments of the present disclosure, an open collector output can be provided at a GPIO pin by configuring the GPIO pin as an input pin to provide a high logic open collector output at an output node associated with the GPIO pin. Further, the GPIO pin can be configured as an output pin having a low logic state to provide a low logic open collector output at the output node associated with the GPIO pin. A current limiting device (e.g. pull-up resistor) coupled between a supply voltage and the output node can be provided such that, when the GPIO pin is configured as an input pin (causing the pin to have a high impedance), the resistor pulls the voltage at the output node towards the supply voltage.

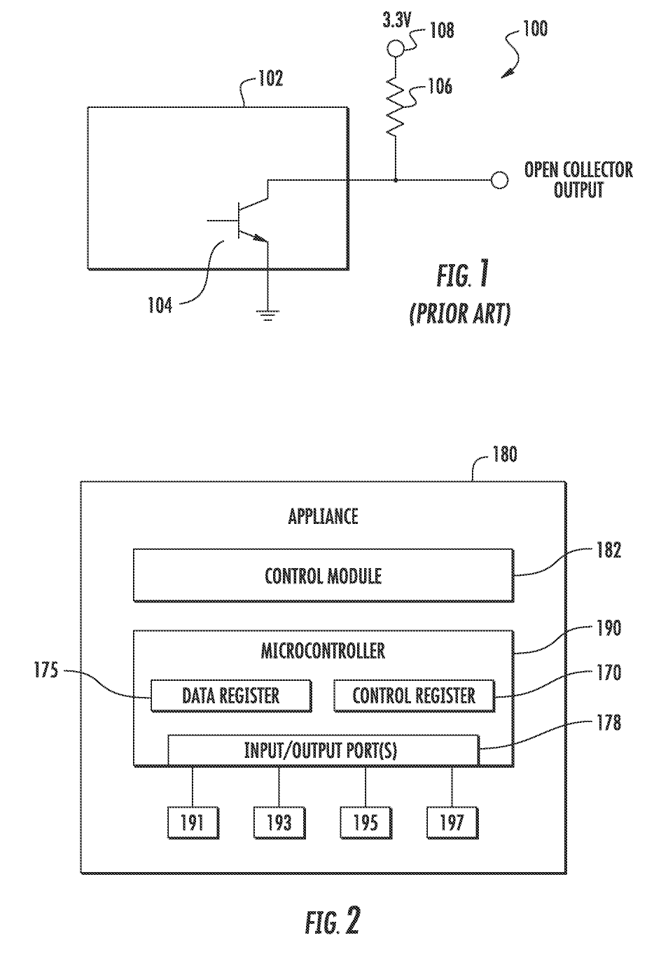

Referring now to the figures, FIG. 2 depicts an example appliance 180 according to example embodiments of the present disclosure. Appliance 180 can include a control module 182 and a microcontroller 190. As used herein, an appliance can be any machine or device for performing a specific task, including, without limitation, an air conditioner, an HVAC system controller, a security system, a camera, a ceiling fan, a clothes dryer, a clothes washer, a stereo system, a dishwasher, an energy delivery system, a refrigerator, a heater, a lighting system, a stove, an oven, a smoke detector, a television, a thermostat, a water heater, a humidity or temperature control device, an ice maker, a garbage disposal, a renewable energy system, an energy storage system, or any other suitable appliance.

Control Module 182 can, in typical embodiments, be configured as an interface between microcontroller 190 and various components of appliance 180. In example embodiments, control module 182 can be included in appliance 180 or can be external to appliance 180. Control module 182 can provide control commands to microcontroller 190, which can be used by microcontroller 190 to provide various functionalities associated with appliance 180. For instance, control module 182 can communicate with various registers associated with microcontroller 190 to configure one or more input and/or output pins of microcontroller 190.

As used herein, the term “module” can be defined as computer logic used to provide desired functionality. As such, a module can be implemented in various manners. For instance, a module can be implemented in hardware devices, application specific circuits, firmware and/or software used to control one or more general purpose processors. In example embodiments, modules can be program code files that are stored on a storage device, loaded into memory and executed by a processor. In alternative embodiments, modules can be provided from computer program products (e.g. computer executable instructions) that are stored in a tangible computer-readable storage medium such as RAM, a hard disk or optical or magnetic media.

Microcontroller 190 may have any number of suitable control devices. For example, the microcontroller 190 can include one or more processor(s) and associated memory device(s) configured to perform a variety of computer-implemented functions and/or instructions (e.g., performing the methods, steps, calculations and the like and storing relevant data as disclosed herein). The instructions when executed by the processor(s) can cause the processor(s) to perform operations according to the present disclosure, such as for instance providing an open collector output at a GPIO pin associated with the microcontroller 190. Further, the microcontroller 190 may include one or more input/output port(s) 178 to interface the microcontroller 190 with various components or devices associated with the appliance. The input/output port(s) 178 may have one or more input/out pin(s) 191-197 that may each be connected to the components or devices. Additionally, the microcontroller 190 may also include a data register 175 and a control register 176 that can be configured to control and/or regulate the input/output pins 191-197.

As used herein, the term “processor” refers not only to integrated circuits referred to in the art as being included in a computer, but also refers to a programmable logic controller (PLC), an application specific integrated circuit, and other programmable circuits. The processor(s) is also configured to compute advanced control algorithms and communicate to a variety of Ethernet or serial-based protocols (Modbus, OPC, CAN, etc.). Additionally, the memory device(s) may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the microcontroller 190 to perform the various functions as described herein. For instance, in typical embodiments, the computer-readable instructions can configure the microcontroller 190 to provide an open collector output at a GPIO pin associated with the microcontroller 190.

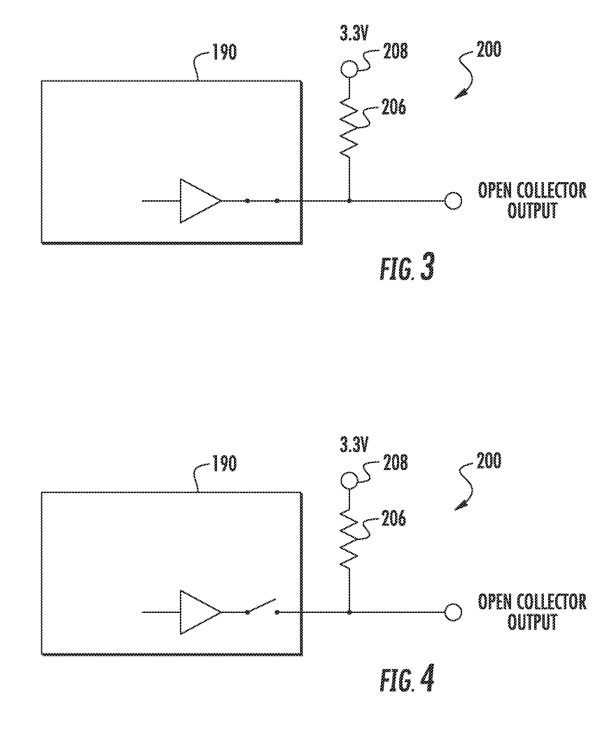

FIGS. 3 and 4 depict an example open collector output configuration 200 at a GPIO pin according to example embodiments of the present disclosure. For instance, FIGS. 3 and 4 can provide the same open collector output functionality as open collector output configuration 100 of FIG. 1. FIGS. 3 and 4 depict a microcontroller, such as microcontroller 190 having a GPIO pin.

As described above, a GPIO pin can be configured as an output pin or an input pin by writing an appropriate value to a control register associated with the pin. For instance, setting a bit in the control register associated with the GPIO pin can configure the GPIO pin as an output pin. Clearing the bit can configure the GPIO pin as an input pin. When configured as an output pin a data register associated with the pin can determine the output logic state at the pin. For instance, writing a logic 1 to the bit in the data register associated with the GPIO pin can drive the pin high. Writing a logic 0 to the bit can drive the GPIO pin low. When configured as an input pin, the signal at the pin can be detected by reading the data register associated with the pin. It will be appreciated by those skilled in the art that various other suitable controller configurations and/or register structures can be used without deviating from the scope of the present disclosure.

Microcontroller 190 can be configured to provide an open collector output at the GPIO pin. For instance, the GPIO pin can be regulated such that it provides an open collector output such as that described with regard to FIG. 1.

In particular, as depicted in FIG. 3, the GPIO pin can be configured as an output pin and driven low to pull the output low (e.g. provide an open collector low logic state at the open collector output node) by providing a low impedance path from the output node to ground. With reference to FIG. 1, such configuration can be analogous to turning on BJT 104 such that a current is allowed to flow through the collector and emitter to ground. As depicted in FIG. 4, the GPIO pin can be configured as an input pin to pull the output high (e.g. provide an open collector high logic state at the open collector output node). With reference to FIG. 1, such configuration can be analogous to turning off BJT 104 such that current flow between the collector and emitter is limited. In particular, configuring the GPIO pin as an input pin provides a high impedance path to ground, thereby pulling the output at the open collector output node towards supply voltage 208.

In example embodiments, a pull-up resistor 206 can be coupled between an external supply voltage 208 and the open collector output node to pull the output at the output node up towards the supply voltage when the GPIO pin is configured as an input pin. Such pull-up resistor configuration can eliminate floating voltages at the output node when the GPIO pin is configured as an input pin. The pull-up resistor value can be between 1 kiloohm and 10 kiloohms, however, other suitable resistor values can be used without deviating from the scope of the present disclosure.

As indicated above, an open collector output can be used in level-shifting between logic levels. Level shifting can be used to step a logic level up or down to facilitate communication between electronic devices operating at different voltage levels. For instance, level shifting can be used to shift a high logic level from 5V to 3.3V (e.g. step down), or to shift a high logic level from 5V to 12V (e.g. step up). Because supply voltage 208 is external to microcontroller 190, the open collector output node can have a different output level than microcontroller 190.

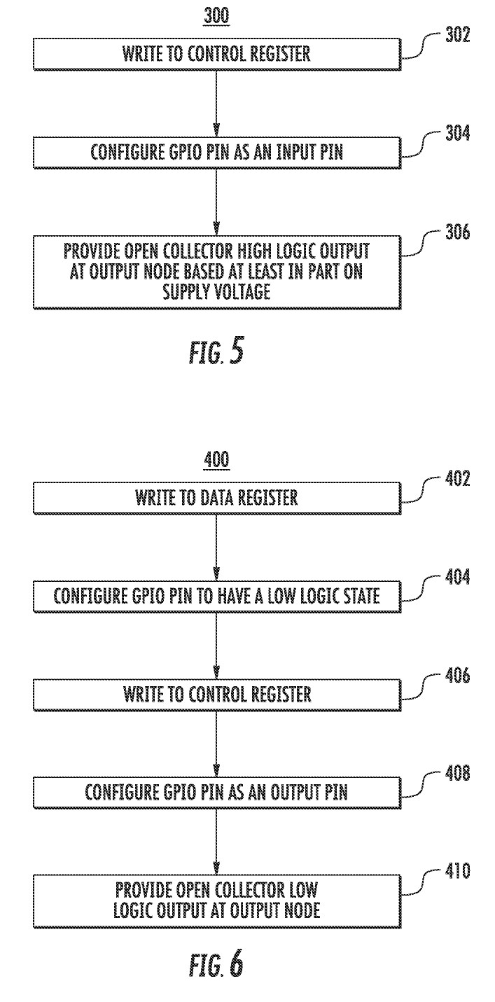

FIG. 5 depicts a flow diagram of an example method (300) of providing an open collector high logic output at a GPIO pin according to example embodiments of the present disclosure. Method (300) can be implemented using any suitable system, including, for example, microcontroller 190 of FIG. 2. In addition, FIG. 5 depicts steps performed in a particular order for purposes of illustration and discussion. Those of ordinary skill in the art, using the disclosures provided herein, will understand that the various steps of any of the methods disclosed herein can be omitted, adapted, and/or rearranged in various ways.

At (302), method (300) can include writing to a control register associated with a microcontroller. At (304), method (300) can include configuring the GPIO pin as an input pin. As described above, the GPIO pin can be configured as an input pin by writing an appropriate value to the control register associated with the GPIO pin. At (306), method (300) can include providing an open collector high logic output at an output node associated with the GPIO pin. As described above, in example embodiments, a pull-up resistor can be coupled between an external supply voltage and the output node to pull the output at the output node up towards the supply voltage when the GPIO pin is configured as an input pin. Such pull-up resistor configuration can eliminate floating voltages at the output node when the GPIO pin is configured as an input pin.

FIG. 6 depicts a flow diagram of an example method (400) of providing an open collector low logic level at a GPIO pin associated with a microcontroller. At (402), method (400) can include writing to a data register associated with the GPIO pin. At (404), method (400) can include configuring the GPIO pin to have a low logic state. As described above, the GPIO pin can be driven to a low logic state or a high logic state when configured as an output pin by writing an appropriate value to a data register associated with the GPIO pin.

At (406), method (400) can include writing to a control register associated with the GPIO pin. At (408), method (400) can include configuring the GPIO pin as an output pin. As described above, the GPIO pin can be configured as an output pin by writing an appropriate value to the control register associated with the GPIO pin. At (410), method (400) can include providing a low logic open collector output at an output node associated with the GPIO pin.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for providing an open collector output, the system comprising:
a general purpose input/output (GPIO) pin associated with one or more processing devices; and
a current limiting device coupled between a supply voltage and an output node associated with the GPIO pin, the supply voltage being external to the one or more processing devices;
wherein the one or more processing devices are configured to provide a first logic level at the output node by setting the GPIO pin as an input pin, the first logic level corresponding to a high logic level, the first logic level being determined based at least in part on the supply voltage.

2. The system of claim 1, wherein the current limiting device is a pull-up resistor.

3. The system of claim 1, wherein the one or more processing devices are further configured to provide a second logic level at the output node by setting the GPIO pin as an output pin and further configuring the GPIO pin to have a low logic output state.

4. The system of claim 3, wherein the second logic level corresponds to a low logic level.

5. The system of claim 1, wherein the one or more processing devices are configured to set the GPIO pin as an input pin based at least in part on a control register associated with the GPIO pin.

6. The system of claim 3, wherein the one or more processing devices are configured to set a logic output state of the GPIO pin based at least in part on a data register associated with the GPIO pin.

7. The system of claim 1, wherein the GPIO pin is further configured as a level shifter.

8. The system of claim 7, wherein the supply voltage is greater than an operating voltage of the one or more processing devices.

9. The system of claim 7, wherein the supply voltage is less than an operating voltage of the one or more processing devices.

10. The system of claim 2, wherein the value of the resistor is between 1,000 and 10,000 ohms.

11. A method of providing an open collector output at a general purpose input/output (GPIO) pin associated with one or more processing devices, the method comprising:
configuring the GPIO pin as an input pin; and
responsive to configuring the GPIO pin as an input pin, providing an open collector high output state at an output node associated with the GPIO pin;
wherein the open collector high output state is determined based at least in part on a supply voltage coupled to the output node, the supply voltage being external to the one or more processing devices.

12. The method of claim 11, wherein a current limiting device is coupled between the supply voltage and the output node.

13. The method of claim 11, further comprising:
configuring the GPIO pin as an output pin;
responsive to configuring the GPIO pin as an output pin, configuring the GPIO pin to have a low logic output state; and
providing an open collector low logic level at the output node.

14. The method of claim 11, wherein configuring the GPIO pin as an input pin comprises writing to a control register associated with the GPIO pin.

15. The method of claim 11, wherein configuring the GPIO pin to have a low logic output state comprises writing to a data register associated with the GPIO pin.

16. An appliance comprising:
one or more processing devices having an associated general purpose input/output (GPIO) pin; and
a current limiting device coupled between a supply voltage and an output node associated with the GPIO pin, the supply voltage being external to the one or more processing devices;
wherein the one or more processing devices are configured to provide a first logic level at the output node by setting the GPIO pin as an input pin, the first logic level corresponding to a high logic level, the first logic level being determined based at least in part on the supply voltage.

17. The appliance of claim 16, wherein the current limiting device is a pull-up resistor.

18. The appliance of claim 16, wherein the one or more processing devices are further configured to provide a second logic level at the output node by setting the GPIO pin as an output pin and further setting the GPIO pin to have a low logic output state.

19. The appliance of claim 18, wherein the second logic level corresponds to a low logic level.

20. The appliance of claim 18, wherein the one or more processing devices are configured to set a logic output state of the GPIO pin based at least in part on a data register associated with the GPIO pin.
